(19) United States
(12) Patent Application Publication
(10) Pub. No.: US 2023/0231262 A1
(43) Pub. Date: Jul. 20, 2023

(54) Secondary Battery

(71) Applicant: LG Energy Solution, Ltd., Seoul (KR)

(72) Inventors: Eun Sun Choi, Daejeon (KR); Kwan Soo Lee, Daejeon (KR); Wook Hee Jang, Daejeon (KR); Jong Pil Jegal, Daejeon (KR)

(73) Assignee: LG Energy Solution, Ltd., Seoul (KR)

(21) Appl. No.: 18/007,817

(22) PCT Filed: Aug. 5, 2021
(86) PCT No.: PCT/KR2021/010315

§ 371 Date: Dec. 2, 2022

(30) Foreign Application Priority Data
Aug. 5, 2020 (KR) 10-2020-0098168
Aug. 4, 2021 (KR) 10-2021-0102809

(51) Int. Cl. H01M 50/342; H01M 50/538; H01M 50/107; H01M 50/152; H01M 50/566; H01M 50/167

(52) U.S. Cl. CPC H01M 50/3425; H01M 50/538; H01M 50/107; H01M 50/152; H01M 50/566; H01M 50/167

(57) ABSTRACT

The present invention relates to a secondary battery. The secondary battery includes an electrode assembly in which electrodes and separators are alternately stacked to be wound, a cylindrical can comprising an accommodation part, in which the electrode assembly is accommodated, the can having an opening, and a cap assembly configured to cover the opening. The cap assembly includes a safety vent comprising a notching part that is ruptured when an internal pressure of the battery increases, the notching part has a circular shape in a plan view, the electrode assembly comprises an electrode tab connected to each of the electrodes, the safety vent is connected to the electrode tab and an external terminal, wherein the electrode tab and the external terminal are connected to different sides of an inner side and an outer side with respect to the notching part in the safety vent in the plane view.

### CROSS-REFERENCE TO RELATED APPLICATION

The present application is a national phase entry under 35 U.S.C. § 371 of International Application No. PCT/KR2021/010315 filed on Aug. 5, 2021, which claims the benefit of the priority of Korean Patent Application Nos. 10-2020-0098168, filed on Aug. 5, 2020, and 10-2021-0102809, filed on Aug. 4, 2021, which are hereby incorporated by reference in their entirety.

### TECHNICAL FIELD

The present invention relates to a secondary battery.

### BACKGROUND ART

Secondary batteries are rechargeable unlike primarily batteries, and also, the possibility of compact size and high capacity is high. Thus, recently, many studies on secondary batteries are being carried out. As technology development and demands for mobile devices increase, the demands for secondary batteries as energy sources are rapidly increasing.

Rechargeable batteries are classified into coin type batteries, cylindrical type batteries, prismatic type batteries, and pouch type batteries according to a shape of a battery case. In such a secondary battery, an electrode assembly mounted in a battery case is a chargeable and dischargeable power generating device having a structure in which an electrode and a separator are stacked.

The electrode assembly may be approximately classified into a jelly roll type electrode assembly in which a separator is interposed between a positive electrode and a negative electrode, each of which is provided as the form of a sheet coated with an active material, and then, the positive electrode, the separator, and the negative electrode are wound, a stacked type electrode assembly in which a plurality of positive and negative electrodes with a separator therebetween are sequentially stacked, and a stack/folding type electrode assembly in which stacked type unit cells are wound together with a separation film having a long length.

Among them, the jelly-roll type electrode assembly is widely used because the jelly-roll type electrode assembly has an advantage is easily manufactured and has high energy density per weight.

In the cylindrical secondary battery comprising existing jelly-roll type electrode assembly, notching is performed in a lower portion of the top cap assembly to facilitate venting of a gas inside the battery when an event of increasing in pressure inside the battery occurs.

In the case of the cylindrical secondary battery without having a top cap and a separate current interrupt device (CID), a positive electrode tab is welded to the lower portion inside the notched portion, and a terminal of a pack or application is welded to an upper portion so that current flows.

The configuration of the current path has a problem in that even if the event occurs inside the battery to be vented, the current is continuously applied to the battery to cause explosion.

In the case of the conventional cylindrical secondary battery having the top cap and the separate current interrupt device (CID), the CID, a safety vent, and the top cap are sequentially provided upward from a lower portion of the cylindrical top cap assembly, and a central portion of the safety vent is bent downward and connected to a top surface of the CID. Also, when a gas is generated inside the battery, the central portion of the safety vent is reversed upward due to the increase in pressure, and the connection between the CID and the safety vent is released and short-circuited. Here, a pressure required for the short circuit is called a CID short-circuit pressure.

In addition, if more gas is generated after the CID is short-circuited, the safety vent is torn, and the internal gas is discharged. Here, the pressure is called a venting pressure.

[Prior Art Document] (Patent Document) Korean Patent Publication No. 10-2016-0010121

### DISCLOSURE OF THE INVENTION

### Technical Problem

One aspect of the present invention is to provide a secondary battery in which current is capable of being cut off when venting occurs due to an internal factor of the battery.

### Technical Solution

A secondary battery according to an embodiment of the present invention comprises: an electrode assembly in which electrodes and separators are alternately stacked to be wound; a cylindrical can comprising an accommodation part, in which the electrode assembly is accommodated, the can having an opened upper portion; and a cap assembly configured to cover an opening of the can, wherein the cap assembly comprises a safety vent comprising a notching part that is ruptured when an internal pressure of the battery increases, the notching part has a circular shape in a plan view, the electrode assembly comprises an electrode tab connected to each of the electrodes, the safety vent is connected to the electrode tab and an external terminal, wherein the electrode tab and the external terminal are connected to different sides of an inner side and an outer side with respect to the notching part in the safety vent in the plane view.

A battery pack according to an embodiment of the present invention may comprise the secondary battery according to an embodiment of the present invention.

### Advantageous Effects

According to the present invention, the electrode tab and the external terminal may be respectively connected to the different sides of the inner side and the outer side with respect to the notching part in the plan view of the safety vent. Thus, when the internal pressure of the battery increases, the notching part is ruptured to cut off the current during the venting.

### BRIEF DESCRIPTION OF THE DRAWINGS

FIG. 1 is a cross-sectional view of a secondary battery according to an embodiment of the present invention.

FIG. 2 is a cross-sectional view illustrating a state in which a notching part of a safety vent is ruptured in the secondary battery according to an embodiment of the present invention.

FIG. 3 is a cross-sectional view illustrating a cap assembly of the secondary battery according to an embodiment of the present invention.

FIG. 4 is a front view illustrating a safety vent in the secondary battery according to an embodiment of the present invention.

FIG. 5 is a cross-sectional view of a secondary battery according to another embodiment of the present invention.

FIG. 6 is a cross-sectional view illustrating a state in which a notching part of a safety vent is ruptured in the secondary battery according to another embodiment of the present invention.

### MODE FOR CARRYING OUT THE INVENTION

The objectives, specific advantages, and novel features of the present invention will become more apparent from the following detailed description taken in conjunction with the accompanying drawings. It should be noted that the reference numerals are added to the components of the drawings in the present specification with the same numerals as possible, even if they are illustrated in other drawings. Also, the present invention may be embodied in different forms and should not be construed as limited to the embodiments set forth herein. In the following description of the present invention, the detailed descriptions of related arts which may unnecessarily obscure the gist of the present invention will be omitted.

### Secondary Battery According to an Embodiment

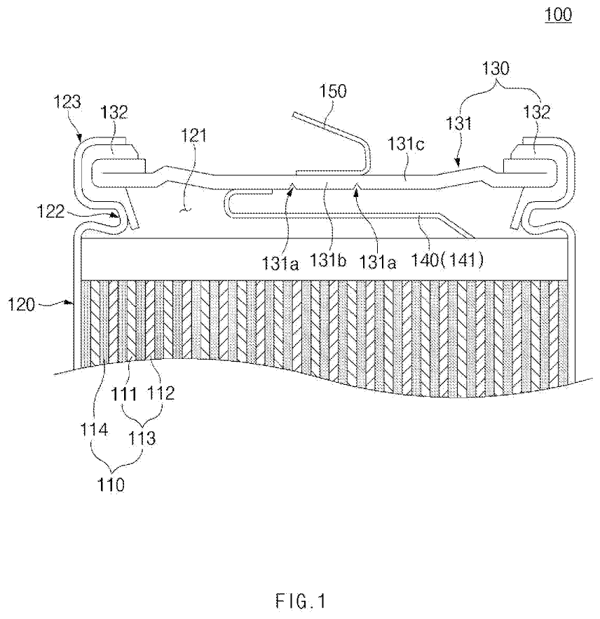

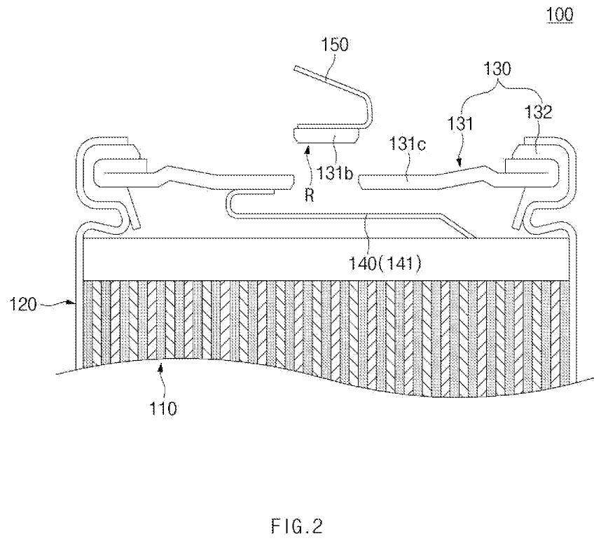

FIG. 1 is a cross-sectional view of a secondary battery according to an embodiment of the present invention, and FIG. 2 is a cross-sectional view illustrating a state in which a notching part of a safety vent is ruptured in the secondary battery according to an embodiment of the present invention.

Referring to FIGS. 1 and 2, a secondary battery 100 according to an embodiment of the present invention comprises an electrode assembly 110, in which electrodes 113 and separators 114 are alternately stacked to be wound, an opened can 120, in which the electrode assembly 110 is accommodated, and a cap assembly 130 covering the opening of the can 120. In addition, the cap assembly 130 comprises a safety vent 131 comprising a notching part 131a that is ruptured when an internal pressure of the battery increases.

Hereinafter, the secondary battery 100 according to an embodiment of the present invention will be described in more detail.

Referring to FIGS. 1 and 2, the electrode assembly 110 may be a chargeable and dischargeable power generation element and have a structure in which the electrodes 113 and the separator 114 are combined and alternately stacked with each other. Here, the electrode assembly 110 may be formed in a shape in which the electrodes 113 and the separator 114 are alternately combined to be wound. Here, the electrode assembly 110 may be wound in a cylindrical shape wound around a central axis.

The electrodes 113 may comprise a positive electrode 112 and a negative electrode 111. Also, the separator 114 separates and electrically insulates the positive electrode 112 and the negative electrode 111 from each other.

The positive electrode 112 may comprise a positive electrode collector and a positive electrode active material provided on one surface of the positive electrode collector. Here, the positive electrode 112 may comprise a positive electrode non-coating portion that is an area on which the positive electrode active material is not stacked.

For example, the positive electrode collector may be provided as foil made of an aluminum material.

The positive electrode active material may comprise lithium manganese oxide, lithium cobalt oxide, lithium nickel oxide, lithium iron phosphate, or a compound or mixture containing at least one of the above-described materials.

The negative electrode 111 may comprise a negative electrode collector and a negative electrode active material stacked on one surface of the negative electrode collector. Here, the negative electrode 111 may comprise a negative electrode non-coating portion that is an area on which the negative electrode active material is not stacked.

The negative electrode collector may be made of, for example, a copper foil made of a copper (Cu) material.

The negative electrode active material may comprise synthetic graphite, lithium a metal, a lithium alloy, carbon, petroleum coke, activated carbon, graphite, a silicon compound, a tin compound, a titanium compound, or an alloy thereof. Here, the negative electrode active material may further comprise, for example, non-graphite-based SiO (silica) or SiC (silicon carbide).

The separator 114 may be made of an insulating material to insulate the positive electrode 112 and the negative electrode 111 from each other.

Also, the separator 114 may be, for example, a multi-layered film produced by microporous polyethylene, polypropylene, or a combination thereof or a polymer film for solid polymer electrolytes or gel-type polymer electrolytes such as polyvinylidene fluoride, polyethylene oxide, polyacrylonitrile, or polyvinylidene fluoride hexafluoropropylene copolymers.

In the secondary battery 100 according to the present invention, the electrode assembly 110 may comprise an electrode tab 140 connected to the electrode.

The electrode tab 140 is attached to the electrode 113 and is electrically connected to the electrode 113.

The electrode tab 140 may comprise a positive electrode tab 141 connected to the positive electrode 112 and a negative electrode tab connected to the negative electrode 111.

Referring to FIG. 1, the positive electrode tab 141 may be formed in a direction in which the cap assembly 130 is disposed, i.e., in an upward direction.

The can 120 may be formed in a cylindrical shape in which an accommodation part 121, in which the electrode assembly 110 is accommodated, is formed, and an upper portion thereof is opened. In this case, the can 120 may be formed, for example, in a cylindrical shape.

The can 120 may be bent toward an inner side 131b to allow the cap assembly 130 to be mounted thereon so that a beading part 122 forming a recessed groove is formed on an outer side 131c. In this case, the cap assembly 130 may be seated on the beading part 122 to cover the opening of the can 120.

The can 120 may comprise a crimping part 123 formed to surround an edge of the cap assembly 130 at an upper portion thereof. Here, the crimping part 123 may comprise an outer circumferential portion formed in a longitudinal direction of the can 120 and an upper end perpendicular to the longitudinal direction of the can 120.

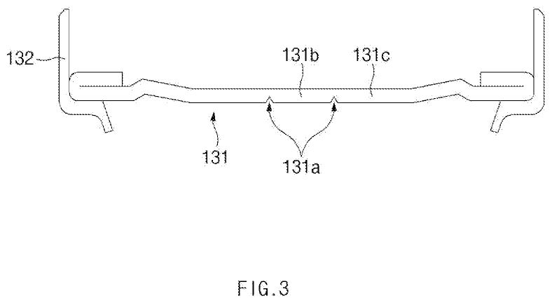

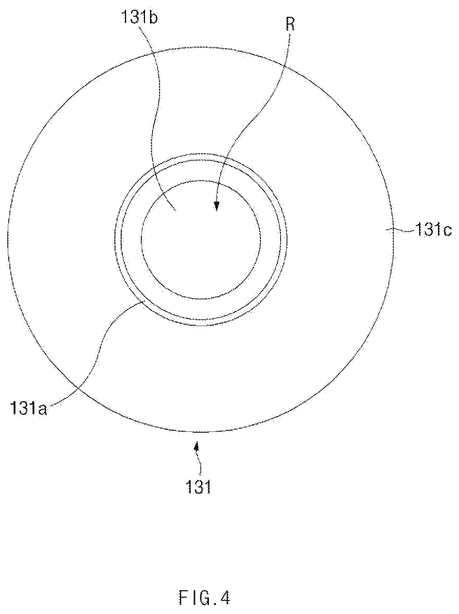

FIG. 3 is a cross-sectional view illustrating the cap assembly of the secondary battery according to an embodiment of the present invention, and FIG. 4 is a front view illustrating a safety vent in the secondary battery according to an embodiment of the present invention.

Referring to FIGS. 1 to 4, the cap assembly 130 may be mounted on an upper portion of the can 120 to cover the opening of the can 120.

The cap assembly 130 may comprise a safety vent 131 comprising a notching part, which is ruptured when an internal pressure of the battery increases, and a gasket 132 that seals a gap between the safety vent 131 and the can 120 to insulate the area between the safety vent 131 and the can 120.

The safety vent 131 may be connected to the electrode tab 140 and an external terminal 150.

When viewed in a plan view, the notching part 131a may be formed in a circular shape on a plane and may be formed at a central portion of the safety vent 131. That is, the notching part 131a may be formed in a circular shape at a central portion on a bottom view illustrated in FIG. 4.

The notching part 131a may be formed on a bottom surface of the safety vent 131. In this case, the notching part 131a may be formed as, for example, a groove having a triangular cross-section.

A distance between a central axis of the safety vent 131 and the notching part 131a may be less than half a radius of the safety vent 131.

The safety vent 131 has a rupture part R ruptured along the notching part 131a at a central side thereof, and when the internal pressure of the battery is greater than or equal to a venting pressure, the notching part 131a may be ruptured so that the rupture part R is separated from the safety vent 131. Here, the venting pressure is referred to as a pressure at which the safety vent 131 is torn due to an increase in internal pressure to generate an internal gas as the internal gas is generated in the battery. As a result, when the internal pressure of the battery due to the generation of the gas in the battery reaches the venting pressure or more, the notching part 131a may be ruptured, and thus, the rupture part R may be separated from the safety vent 131 to cut off the current.

A gasket 132 may be provided along an outer circumferential surface of the safety vent 131 to surround an edge of the safety vent 131. Here, the crimping part 123 of the can 120 may be formed to surround the outer side 131c of the gasket 132 to seal a gap between the can 120 and the cap assembly 130.

The cap assembly 130 of the secondary battery according to an embodiment of the present invention may be constituted by the safety vent 131 and the gasket 132 without a current interrupt device (CID), a filter, and a CID gasket. Thus, the components may be simplified, and manufacturing cost may be reduced. As a result, there is an effect of reducing battery resistance and improving performance due to the simplification of the components.

The electrode tab 140 and the external terminal 150 may be connected to different sides of the inner side 131b and the outer side 131c with respect to the notching part 131a in the plan view of the safety vent 131. Here, the electrode tab 140 may be connected to the outer side 131c of the notching part 131a of the safety vent 131 in the plan view, and the external terminal 150 may be connected to the inner side 131b of the notching part 131a of the safety vent 131 in the plan view.

In the electrode tab 140, the positive electrode tab 141 may be provided at an upper side of the electrode assembly 110 and be connected to a lower end of the safety vent 131, and the external terminal 150 may be connected to an upper end of the safety vent 131.

In addition, the positive electrode tab 141 may be welded to a lower end of the safety vent 131, and the external terminal 150 may be welded to an upper end of the safety vent 131.

The external terminal 150 may be provided as a connection wire of an external pack or application.

Referring to FIG. 1, in the secondary battery 100, which is configured as described above, according to an embodiment of the present invention, the external terminal 150 may be connected to the inner side 131b with respect to the notching part 131a of the safety vent 131 in the plan view, and the electrode tab 140 may be connected to the outer side 131c.

Thus, referring to FIG. 2, as the internal pressure increases due to an increase in the internal gas, the notching part 131a may be ruptured to cut off the current during the venting. That is, when the notching part 131a forming a circular notching line in the plan view is ruptured, the rupture part R may be separated from the safety vent 131, and the electrical connection between the external terminal 150 fixed to the rupture part R, i.e., the inner side 131b of the safety vent 131, and the electrode tab 140 fixed to the outer side 131c of the safety vent 131 may be released.

As a result, when the venting occurs due to the increase in internal pressure, in the safety vent 131, the inner side 131b of the notching part 131a, which is connected to the external terminal 150, may be ruptured and then separated from the outer side 131c of the notching part 131a connected to the electrode tab 140 to completely cut off the current, thereby preventing the secondary battery from being exploded due to the continuous apply of the current.

### Secondary Battery According to Another Embodiment

Hereinafter, a secondary battery according to another embodiment will be described.

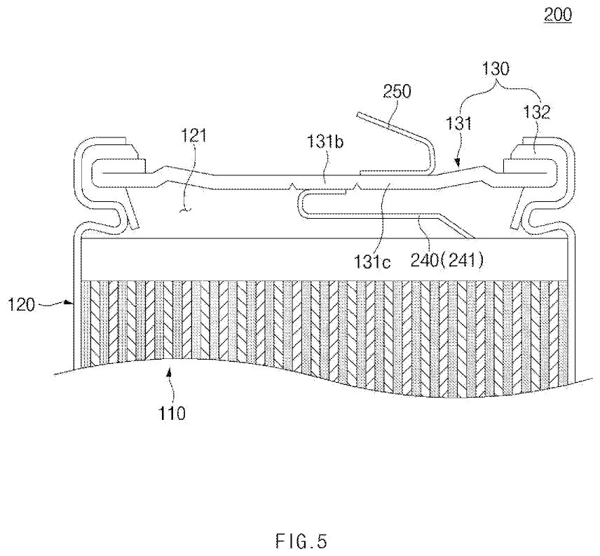

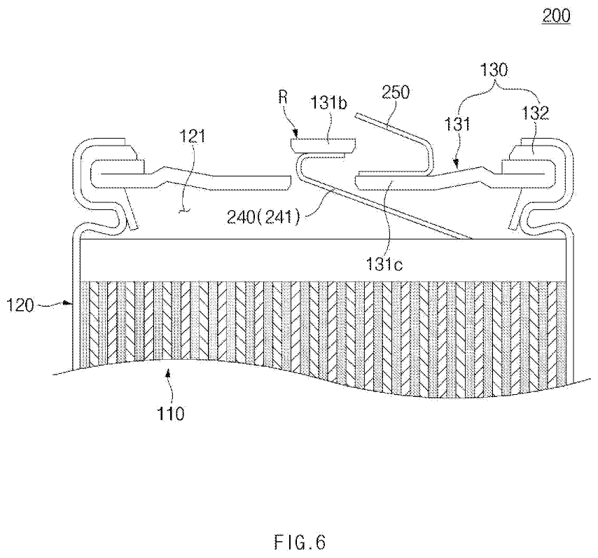

FIG. 5 is a cross-sectional view of a secondary battery according to another embodiment of the present invention, and FIG. 6 is a cross-sectional view illustrating a state in which a notching part of a safety vent is ruptured in the secondary battery according to another embodiment of the present invention.

Referring to FIGS. 5 and 6, a secondary battery 200 according to another embodiment of the present invention comprises an electrode assembly 110, in which electrodes 113 and separators 114 are alternately stacked to be wound, an opened can 120, in which the electrode assembly 110 is accommodated, and a cap assembly 130 covering the opening of the can 120. In addition, the cap assembly 130 comprises a safety vent 131 comprising a notching part 131a that is ruptured when an internal pressure of the battery increases.

The secondary battery 200 according to another embodiment of the present invention is different from the secondary battery according to the foregoing embodiment of the present invention in connection positions of an electrode tab 240, an external terminal, and a safety vent 131. Thus, contents of this embodiment, which are duplicated with those according to the forgoing embodiment, will be omitted or briefly described, and also, differences therebetween will be mainly described.

In more detail, the electrode assembly 110 may be a chargeable and dischargeable power generation element and have a structure in which an electrode 113 and a separator 114 are combined and alternately stacked. Here, the electrode assembly 110 may be formed in a shape in which the electrodes 113 and the separator 114 are alternately combined to be wound. Here, the electrode assembly 110 may be wound in a cylindrical shape wound around a central axis.

The electrodes 113 may comprise a positive electrode 112 and a negative electrode 111. Also, the separator 114 separates and electrically insulates the positive electrode 112 and the negative electrode 111 from each other.

In the secondary battery 200 according to the present invention, the electrode assembly 110 may comprise an electrode tab 240 connected to the electrode 113.

The electrode tab 240 is attached to the electrode 113 and is electrically connected to the electrode 113.

The electrode tab 240 may comprise a positive electrode tab 241 connected to the positive electrode 112 and a negative electrode tab connected to the negative electrode 111.

The positive electrode tab 241 may be formed in a direction in which the cap assembly 130 is disposed, i.e., in an upward direction.

The can 120 may be formed in a cylindrical shape in which an accommodation part 121, in which the electrode assembly 110 is accommodated, is formed, and an upper portion thereof is opened. In this case, the can 120 may be formed, for example, in a cylindrical shape.

The can 120 may be bent toward an inner side 131b to allow the cap assembly 130 to be mounted thereon so that a beading part 122 forming a recessed groove is formed on an outer side 131c. In this case, the cap assembly 130 may be seated on the beading part 122 to cover the opening of the can 120.

The can 120 may comprise a crimping part formed to surround an edge of the cap assembly 130 at an upper portion thereof. Here, the crimping part 123 may comprise an outer circumferential portion formed in a longitudinal direction of the can 120 and an upper end perpendicular to the longitudinal direction of the can 120.

The cap assembly 130 may be mounted on an upper portion of the can 120 to cover the opening of the can 120.

The cap assembly 130 may comprise a safety vent 131 comprising a notching part 131a, which is ruptured when an internal pressure of the battery increases, and a gasket 132 that seals a gap between the safety vent 131 and the can 120 to insulates between the safety vent 131 and the can 120.

The safety vent 131 may be connected to the electrode tab 240 and an external terminal 250.

The notching part 131a may be formed at a central portion of the safety vent 131 in the plan view.

A distance between a central axis of the safety vent 131 and the notching part 131a may be less than half a radius of the safety vent 131.

The safety vent 131 has a rupture part R ruptured along the notching part 131a at a central side thereof, and when the internal pressure of the battery is greater than or equal to a venting pressure, the notching part 131a may be ruptured so that the rupture part R is separated from the safety vent 131.

The electrode tab 240 and the external terminal 250 may be connected to different sides of the inner side 131b and the outer side 131c with respect to the notching part 131a in the plan view of the safety vent 131. Here, the electrode tab 240 may be connected to the inner side 131b of the notching part 131a of the safety vent 131 in the plan view, and the external terminal 250 may be connected to the outer side 131c of the notching part 131a of the safety vent 131 in the plan view.

The positive electrode tab 241 may be provided at an upper side of the electrode assembly 110 and be connected to a lower end of the safety vent 131, and the external terminal 250 may be connected to an upper end of the safety vent 131.

The positive electrode tab 241 may be welded to a lower end of the safety vent 131, and the external terminal 250 may be welded to an upper end of the safety vent 131.

The external terminal 250 may be provided as a connection wire of an external pack or application.

Referring to FIG. 5, in the secondary battery 200, which is configured as described above, according to another embodiment of the present invention, the external terminal 250 may be connected to the outer side 131c with respect to the notching part 131a of the safety vent 131 in the plan view, and the electrode tab 240 may be connected to the inner side 131b.

Thus, referring to FIG. 6, as the internal pressure increases due to an increase in the internal gas, the notching part 131a may be ruptured to cut off the current during the venting. That is, when the notching part 131a forming a circular notching line in the plan view is ruptured, the rupture part R may be separated from the safety vent 131, and the electrical connection between the electrode tab 240 fixed to the rupture part R, i.e., the inner side 131b of the notching part 131a of the safety vent 131 and the external terminal 250 connected to the outer side 131c of the notching part 131a may be released.

As a result, when the venting occurs due to the increase in internal pressure, in the safety vent 131, the inner side 131b of the notching part 131a, which is connected to the positive electrode tab 241 of the electrode tab 240, may be ruptured and then separated from the outer side 131c of the notching part 131a connected to the external terminal 250 to completely cut off the current, thereby preventing the secondary battery from being exploded due to the continuous apply of the current.

Here, an insulation film may be applied to an outer surface of the positive electrode tab 241 to completely prevent the positive electrode tab 241 from being in contact with the outer side 131c of the notching part 131a, to which the external terminal 250 is fixed, in the safety vent 131 when the rupture part R is separated from the safety vent 131, and thus, the positive electrode tab 241 fixed to the rupture part R moves.

A battery pack may comprise a plurality of secondary batteries, each of which is configured as described above. The battery pack may be provided in shape, in which the plurality of secondary batteries are electrically connected to each other and then are accommodated in the battery pack. Here, the plurality of secondary batteries may be connected to each other through a connection wire. In this case, the connection wire may be connected to the upper end of the safety vent in the secondary battery as the external terminal.

While the present invention has been particularly shown and described with reference to exemplary embodiments thereof, it is to be understood that the scope of the present invention is not limited thereto. It will be understood by those of ordinary skill in the art that various changes in form and details may be made therein without departing from the spirit and scope of the present invention.

Furthermore, the scope of protection of the present invention will be clarified by the appended claims.

### DESCRIPTION OF THE SYMBOLS

100, 200: Secondary battery

110: Electrode assembly

111: Negative electrode

112: Positive electrode

113: Electrode

114: Separator

120: Can

121: Accommodation part

122: Beading part

123: Crimping part

130: Cap assembly

131: Safety vent

131a: Notching part

131b: Inner side

131c: Outer side

132: Gasket

140, 240: Electrode tab

141, 241: Positive electrode tab

150, 250: External terminal

R: Rupture part

1. A secondary battery comprising:
an electrode assembly in which electrodes and separators are alternately stacked to be wound;
a cylindrical can comprising an accommodation part, in which the electrode assembly is accommodated, the can having an opening at an upper portion; and
a cap assembly configured to cover the opening of the can, wherein the cap assembly comprises a safety vent comprising a notching part that is ruptured when an internal pressure of the battery is equal to or greater than a predetermined venting pressure,
the notching part has a circular shape in a plan view,
the electrode assembly comprises an electrode tab connected to each of the electrodes,
the safety vent is connected to the electrode tab and an external terminal, wherein the electrode tab and the external terminal are connected to different sides of an inner side and an outer side with respect to the notching part in the safety vent in the plane view.

2. The secondary battery of claim 1, wherein the electrode tab is connected to the outer side of the notching part of the safety vent in the plan view, and
the external terminal is connected to the inner side of the notching part of the safety vent in the plan view.

3. The secondary battery of claim 1, wherein the electrode tab is connected to the inner side of the notching part of the safety vent in the plan view, and
the external terminal is connected to the outer side of the notching part of the safety vent in the plan view.

4. The secondary battery of claim 1, wherein the electrodes comprise a positive electrode and a negative electrode,
the electrode tab comprises a positive electrode tab connected to the positive electrode,
the positive electrode tab is provided at an upper side of the electrode assembly and is connected to a lower end of the safety vent, and
the external terminal is connected to an upper end of the safety vent.

5. The secondary battery of claim 4, wherein the positive electrode tab is welded to a lower end of the safety vent, and the external terminal is welded to the upper end of the safety vent.

6. The secondary battery of claim 1, wherein the external terminal is provided as connection wire of an external pack or application.

7. The secondary battery of claim 1, wherein the notching part is formed at a central portion of the safety vent in the plan view.

8. The secondary battery of claim 1, wherein the cap assembly further comprises a gasket configured to seal a gap between the safety vent and the can and insulate the safety vent and the can from each other,
the can comprises a crimping part formed to surround the gasket so as to fix the cap assembly.

9. The secondary battery of claim 1, wherein a distance between a central axis of the safety vent and the notching part is less than half a radius of the safety vent.

10. The secondary battery of claim 1, wherein the safety vent comprises a rupture part that is arranged to rupture along the notching part at a central side thereof, and
when the internal pressure of the battery is greater than or equal to the predetermined venting pressure, the notching part is ruptured so that the rupture part is separated from the safety vent.

11. A battery pack comprising the secondary battery of claim 1.
